(19) United States
(12) Patent Application Publication
(10) Pub. No.: US 2026/0137220 A1
(43) Pub. Date: May 21, 2026

(54) Certification Label with an Opening for a Secondary Memorabilia

(71) Applicant: Dempsey & Baxter, LLC, Erie, PA (US)

(72) Inventor: Christopher Dempsey, Erie, PA (US)

(73) Assignee: Dempsey & Baxter, LLC, Erie, PA (US)

(21) Appl. No.: 19/364,986

(22) Filed: Oct. 21, 2025

Related U.S. Application Data
(60) Provisional application No. 63/710,009, filed on Oct. 21, 2024.

(51) Int. Cl. A47G 1/12; B65D 25/10; B65D 25/20; G09F 3/02

(52) U.S. Cl. CPC A47G 1/12; B65D 25/108; B65D 25/205; G09F 3/02; G09F 2003/0208

(57) ABSTRACT

A certification label for a memorabilia holder comprises a certification area to identify, document, and certify a primary memorabilia and a secondary memorabilia. The certification label has an opening to receive the secondary memorabilia.

### BACKGROUND

Collectables and memorabilia have long been stored, purchased, traded, and sold, in variety of holders and cases that usually incorporate some sort of certification label that identifies, documents, and certifies the authenticity of the memorabilia contained in the holder. What is presented is an improvement to the certification label that adds value to the holder.

### SUMMARY

What is presented is a memorabilia holder comprising a primary memorabilia within the memorabilia holder and a certification label having a certification area identifying and certifying the primary memorabilia. The certification label has a cutout to accommodate a secondary memorabilia and the certification label further identifies and certifies the secondary memorabilia.

In some embodiments the cutout is completely contained within certification label. In some embodiments, a mounting system is used to secure the primary memorabilia within the memorabilia holder. In some embodiments, a mounting system secures both the primary memorabilia and the secondary memorabilia withing the memorabilia holder. In some embodiments, the secondary memorabilia is mounted to the certification label. The certification label may have certification information on both sides.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 shows an exploded view of an embodiment of memorabilia holder with a primary memorabilia and having a certification label that has a cutout to accommodate a secondary memorabilia;

FIG. 2 shows a perspective view of the assembled memorabilia holder of FIG. 1; and

FIG. 3 shows a perspective view of another embodiment of memorabilia holder with a different configuration of certification label.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

Collectors of memorabilia typically add value to their collections by obtaining certificates of authenticity for their collectable. Depending on what is being authenticated, there are third-party authentication and grading services that will review, document, certify, and package the collectable in such a way that the collectable can be protected from the elements and be viewed alongside some documentation of authenticity. The memorabilia/collectables may be coins, comic books, collectable cards (from sports teams, card games, etc.), event tickets, photographs, bank notes, etc. The collector sends the memorabilia for grading and certification to the third-party grading service that reviews and certifies the memorabilia and encapsulates it within a tamper-evident memorabilia holder. The memorabilia holder typically includes a certification label that has identifies the memorabilia and certifies its authenticity.

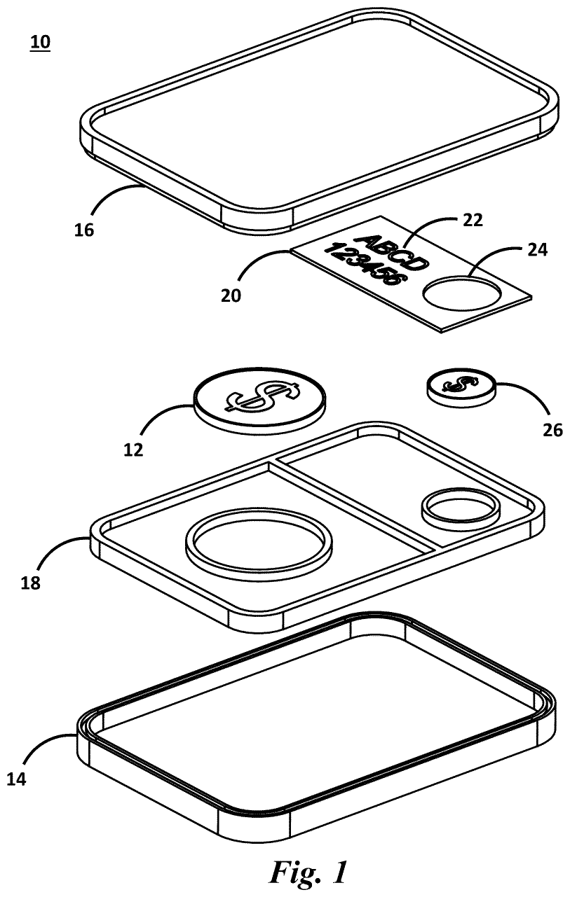

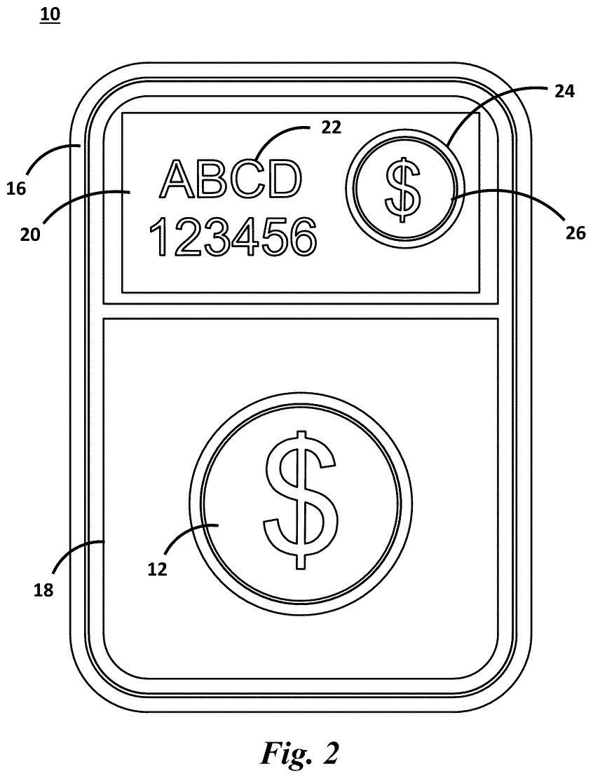

As best understood by comparing FIGS. 1 and 2, a memorabilia holder 10 is used to contain a primary memorabilia 12. There are many variations of memorabilia holder 10 but the embodiment shown in FIGS. 1 and 2 comprise a base 14 and a cap 16. If it is necessary for the primary memorabilia 12 to be stationary within the memorabilia holder 10, a mounting system 18 is used to secure the primary memorabilia 12 within the memorabilia holder 10. The memorabilia holder 10 is typically made of see-through material that allows the contents within it to be examined. A certification label 20 is also included within the memorabilia holder 10. The certification label 20 has a certification area 22 that identifies and certifies the primary memorabilia 12. It will be understood that the size of the memorabilia holder 10 can vary depending on the dimension of the primary memorabilia 12 that is housed within it, but in general collectible coins as shown in the figures are typically certified in “deck of card” sized memorabilia holders 10 with a certification label 20 that takes up about a third of the top of the memorabilia holder 10, and a coin area below that comprises the remainder of the memorabilia holder 10. For other types of primary memorabilia 12, such as collectable cards, currency, books, etc. are similarly sized to contain the memorabilia, the memorabilia holder 10 will accommodate the item and will have a certification label 20 associated with the item.

Certification labels 20 vary in size depending on the size of the memorabilia holder 10 but for collectable coins as shown in the figures, the certification labels 20 are generally about 2 inches by 1 inch of paper, foil, or other thin material. Certification labels 20 provide information about the contents of the memorabilia holder 10, their condition, serial number, a bar code, company information, and label specific art. The certification label has a cutout 24 to receive a secondary memorabilia 26. The certification area 22 also identifies and certifies the secondary memorabilia 26. In the embodiment shown in FIGS. 1 and 2, the cutout 24 is completely contained within the certification label 20. This allows for two memorabilia to be included within a single memorabilia holder 10 and increases the value and uniqueness to the consumer.

The secondary memorabilia 26 can be any piece of memorabilia but it would be understood that it could be related to the primary memorabilia 12 in some way. For example, if the primary memorabilia 12 is a collectable coin from a movie franchise, the secondary memorabilia 26 could be a piece of art, a cut out from a script, or a piece of fabric from a costume worn in the movie. A memorabilia holder 10 that has two pieces of memorabilia as shown has increased marketability and gives collectable dealers more flexible pricing and marketing options.

If necessary, the secondary memorabilia 26 is mounted with the mounting system 18. The secondary memorabilia 26 may instead be mounted to the certification label 20. The certification label 20 may have certification information on both sides.

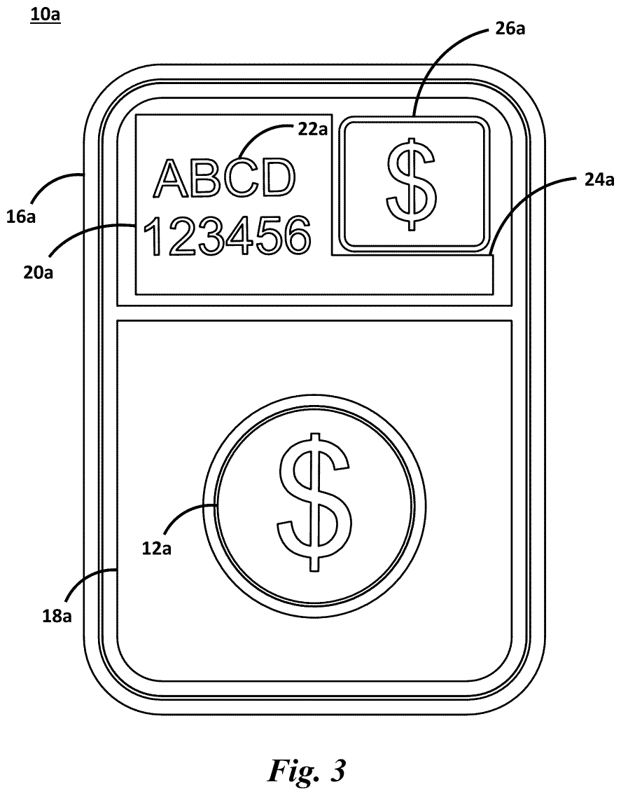

FIG. 3 shows a variation of the memorabilia holder 10a in which the cutout 24a of the certification label 20a is such that the secondary memorabilia 26a is only partially framed by the certification label 20a. This variation would accommodate slightly larger secondary memorabilia 26a that would not fit within the embodiments shown in earlier figures.

While the embodiment shown in the figures are numismatic collectables, it is understand that the modified certification label would equally apply to non-numismatic collectibles such as comic books, collectable cards (from sports teams, card games, etc.), event tickets, photographs, bank notes, etc. The modified certification label allows for standard memorabilia holders to be converted into systems that hold a secondary memorabilia with little to no change to the memorabilia holders and is an immediate value-added feature.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A memorabilia holder comprising:
a primary memorabilia within the memorabilia holder;
a certification label having a certification area identifying and certifying said primary memorabilia;
said certification label having a cutout to accommodate a secondary memorabilia; and
said certification area further identifying and certifying said secondary memorabilia.

2. The memorabilia holder of claim 1 further comprising said cutout is completely contained within said certification label.

3. The memorabilia holder of claim 1 further comprising a mounting system to secure said primary memorabilia within the memorabilia holder.

4. The memorabilia holder of claim 1 further comprising a mounting system to secure said primary memorabilia and said secondary memorabilia within the memorabilia holder.

5. The memorabilia holder of claim 1 further comprising said secondary memorabilia is mounted to said certification label.

6. The memorabilia holder of claim 1 further comprising said certification label having certification information on both sides.

7. A certification label for a memorabilia holder comprising:
a certification area to identify, document, and certify a primary memorabilia and a secondary memorabilia; and
an opening to accommodate said secondary certification.

8. The certification label of claim 6 further comprising said cutout is completely contained within said certification label.

9. The certification label of claim 6 further comprising said label having certification information on both sides.
